(19) United States
(12) Patent Application Publication
(10) Pub. No.: US 2023/0042141 A1
(43) Pub. Date: Feb. 9, 2023

(54) IMAGING DEVICE, ASSEMBLY, AND METHOD FOR PERFORMING REAL-TIME CORING USING THE IMAGING DEVICE DURING DRILLING OPERATIONS

(71) Applicant: SAUDI ARABIAN OIL COMPANY, Dhahran (SA)

(72) Inventors: Mauricio Guiza Medina, Alkhobar (SA); Bander S. Al-Malki, Dammam (SA); Oscar D. Bautista, Dhahran (SA)

(73) Assignee: SAUDI ARABIAN OIL COMPANY, Dhahran (SA)

(21) Appl. No.: 17/394,045

(22) Filed: Aug. 4, 2021

(51) Int. Cl. G01V 3/32; G01V 3/28; G01V 3/30

(52) U.S. Cl. CPC G01V 3/32; G01V 3/28; G01V 3/30; E21B 49/00

(57) ABSTRACT

An imaging device included in an assembly located in a wellbore during drilling operations may include a cylindrical housing that extends along a central axis thereof. The imaging device may include at least one gradient coil configured to produce a unique magnetic field weaker than a main magnetic field. The at least one gradient coil may create a variable field that is increased or decreased by changing a direction of the unique magnetic field with respect to a direction of the main magnetic field to allow a specific part of a rock formation to be scanned by altering and adjusting the main magnetic field. The imaging device may include at least one radio frequency coil configured to transmit radio frequency waves into the rock formation. The imaging device may include at least one magnet disposed in the cylindrical housing that resonates against the unique magnetic field.

### BACKGROUND

Conventional cores, also known as whole cores, are continuous sections of rock extracted from a formation in a process similar to conventional drilling. Coring and conventional drilling operations differ mainly in the type of bit used, because instead of a drilling bit, coring relies on a hollow bit and a core barrel in a bottomhole assembly (BHA). Coring is used to evaluate rock properties from cores taken from hydrocarbon wells. These rock properties may be measured using techniques and equipment commonly found in laboratories. These laboratories are located on a surface area of a well site or located at a remote location. Usually, before the cores reach a laboratory, they must first be extracted from rock formations below the Earth's surface. The process of obtaining these cores may yield different rock samples based on the extraction technique implemented. During handling of the cores, the integrity of the rock formation represented in the cores may be compromised. This mishandling may provide inaccurate information for future planning and development of a hydrocarbon field. Currently, there are no tools or processes that provide rock properties of rock formations at downhole conditions without the need to cutting cores or extracting cores for sampling at laboratories.

### SUMMARY

In general, in one aspect, embodiments disclosed herein relate to an imaging device included in an assembly located in a wellbore during drilling operations. The imaging device includes a cylindrical housing that extends along a central axis thereof. The imaging device includes at least one gradient coil configured to produce a unique magnetic field weaker than a main magnetic field. The at least one gradient coil creates a variable field that is increased or decreased by changing a direction of the unique magnetic field with respect to a direction of the main magnetic field to allow a specific part of a rock formation to be scanned by altering and adjusting the main magnetic field. The imaging device includes at least one radio frequency coil configured to transmit radio frequency waves into the rock formation. The imaging device includes at least one magnet disposed in the cylindrical housing that resonates against the unique magnetic field and the radio frequency waves. The imaging device includes at least one collector sensor that monitors a status of the rock formation during the drilling operations. The imaging device includes a power source dedicated to powering the imaging device. The imagine device includes a processor that performs real-time coring during the drilling operations. The real-time coring includes identifying one or more downhole characteristics in real-time.

In general, in one aspect, embodiments disclosed herein relate to an assembly located in a wellbore during drilling operations. The assembly includes a piping element including an aperture that extends along a central axis thereof. The assembly includes an imaging device. The imaging device includes a cylindrical housing that extends along the central axis. The imaging device includes at least one gradient coil configured to produce a unique magnetic field weaker than a main magnetic field. The at least one gradient coil creates a variable field that is increased or decreased by changing a direction of the unique magnetic field with respect to a direction of the main magnetic field to allow a specific part of a rock formation to be scanned by altering and adjusting the main magnetic field. The imaging device includes a radio frequency coil configured to transmit radio frequency waves into the rock formation. The imaging device includes at least one magnet disposed in the cylindrical housing that resonates against the unique magnetic field and the radio frequency waves. The imaging device includes at least one collector sensor that monitors a status of the rock formation during the drilling operations. The imaging device includes a power source dedicated to powering the imaging device. The imaging device includes a processor that performs real-time coring during the drilling operations. The real-time coring includes identifying one or more downhole characteristics in real-time. The assembly includes a drilling bit including various drilling elements that assist in crushing or cutting the rock formation.

In general, in one aspect, embodiments disclosed herein relate to a method for performing real-time coring using an imaging device included in an assembly located in a wellbore during drilling operations. The method includes producing, by at least one gradient coil, a unique magnetic field weaker than a main magnetic field. The method includes creating, by the at least one gradient coil, a variable field that is increased or decreased by changing a direction of the unique magnetic field with respect to a direction of the main magnetic field to allow a specific part of a rock formation to be scanned by altering and adjusting the main magnetic field. The method includes transmitting, by a radio frequency coil, radio frequency waves into the rock formation. The method includes resonating, by at least one magnet, against the unique magnetic field and the radio frequency waves, the at least one magnet being disposed in a cylindrical housing. The method includes monitoring, by at least one collector sensor, a status of the rock formation during the drilling operations. The method includes performing, using a processor, real-time coring during the drilling operations. The real-time coring including identifying one or more downhole characteristics in real-time. The imaging device includes a power source dedicated to powering the imaging device.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a schematic diagram showing a perspective view of an assembly including an imaging device in accordance with one or more embodiments.

FIG. 2 shows a schematic diagram of an imaging device in accordance with one or more embodiments.

FIG. 3 shows a schematic diagram showing a cross-section view of an imaging device in accordance with one or more embodiments.

FIG. 4 shows a schematic diagram showing a perspective view of an imaging device in accordance with one or more embodiments.

FIG. 5 shows a schematic diagram of a system including an assembly in accordance with one or more embodiments.

FIGS. 6A and 6B show examples of imaging outputs in accordance with one or more embodiments.

FIG. 7 shows a schematic diagram of a method for performing real-time coring in accordance with one or more embodiments.

FIG. 8 shows a schematic diagram of a method for performing real-time coring in accordance with one or more embodiments.

FIG. 9 shows a flowchart in accordance with one or more embodiments.

FIG. 10 shows an example of a computer system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include an imaging device, an assembly, and a method for performing real-time coring using the imaging device. The assembly may be a bottomhole assembly (BHA) that includes a piping element, the imaging device, and a drilling bit. The imaging device may be operated while the drilling bit is performing drilling operations. In some embodiments, the imaging device is a Magnetic Resonance Imaging Tool (MRIT) that performs imaging operations such as retrieving imaging information relating to changes in electromagnetic fields and radio frequency waves in a rock formation adjacent to the imaging device. The imaging information retrieved may be detailed information indicating subtle changes in the rock formation. The imaging information may be used for performing coring in real-time as the BHA is lowered into the formation. In this case, as coring may be performed without requiring laboratory sampling of physical cores of the rock formation, a virtual type of coring (i.e., virtual coring) is implemented.

In virtual coring, the cores being sampled are in the immediate area surrounding the imaging device over a predetermined radius. As the BHA moves downward, new virtual cores may be obtained using the imaging device. These virtual cores may be saved in a storage device while they are processed in real time using a scanning engine. Further, the imaging device may establish a communication link with one or more control systems in which the virtual cores may be stored or further evaluated.

In one or more embodiments, the imaging device, the assembly, and the method improve the timing require for drilling a wellbore and coring by eliminating any time required to measure rock properties in laboratories. In this regard, because the virtual cores are not retrieved from the rock formation, the imaging device, the assembly, and the method may eliminate the introduction of impurities in any core samples evaluated. In some embodiments, measuring rock properties at downhole condition from the virtual cores may be implemented while using a streamlined evaluation process. The virtual cores may be composite images formed from sensory feedback received from the rock formation. As such, the virtual cores may be representative of petrophysical properties (i.e., rock formation characteristics) at downhole conditions. These rock formation characteristics may include fluid saturation, permeability, or porosity of the rock formation. Without the need to of cutting cores and through the acquisition of three-dimensional (3D) imaging, all the referred rock formation characteristics and pore size may be measured with a higher level of accuracy when compared with conventional coring techniques.

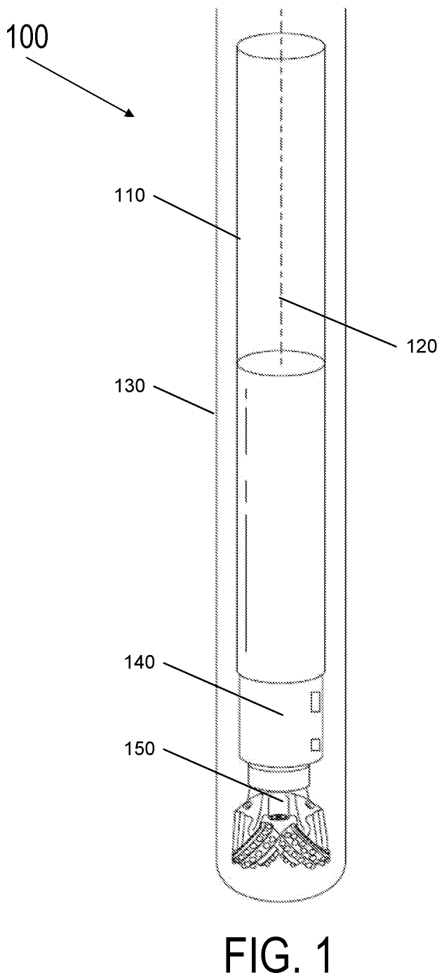

FIG. 1 shows a schematic diagram illustrating an assembly 100 configured for being disposed on a wellbore 130 of a well system in accordance to one or more embodiments. The assembly 100 may include a piping element 110, an imaging device 140, and a drilling bit 150. The assembly 100 may be a bottomhole assembly (BHA) that extends along a central axis 120 thereof such that the bottommost portion of the assembly 100 is the drilling bit 150. The assembly 100 may have a cylindrical housing that extends through the entire length of the piping element 110 and the imaging device 140 along the central axis 120. The assembly 100 may be lowered and raised through drilling of the wellbore 130 to sample rock formations adjacent to the assembly 100. The assembly 100 may be lowered along the wellbore 130 using a conveyance mechanism. In this regard, the assembly 100 may obtain images to identify one or more downhole characteristics.

In some embodiments, the piping element 110 is hollow, thin-walled, steel or aluminum alloy piping that is used on drilling rigs. In this regard, the piping element 110 may be hollow to allow drilling fluid to be pumped down the hole through the drilling bit 150 and back up the annulus. The piping element 110 may be in a variety of sizes, strengths, and wall thicknesses. In some embodiments, the piping element 110 may be between 27 and 32 feet in length, inclusive. In some embodiments, the piping element 110 may be larger than 45 feet in length.

In some embodiments, the imaging device 140 is a Magnetic Resonance Imaging Tool (MRIT) or hardware configured for performing MRI scanning of a rock formation. The MRIT may produce detailed images of a rock formation by tracking the behavior of water in a rock formation. In this regard, the MRI improves over Nuclear Magnetic Resonance (NMR) spectroscopy because NMR solely generates information (i.e., a spectrum of light corresponding to a chemical structure) based on a frequency of an emitted radiation, which is related to the speed of the jiggling protons. Instead, the imaging device 140 generates images of the rock formations surrounding the imaging device 140 using the intensity of radiation (i.e., the quantity of re-emitted photons) arriving from various parts of the rock formation. Protons in dense or solid structures may be more or less prone to misalignment when disrupting radio waves are applied to the rock formation, resulting in a lower number of re-emitted photons coming from that region and thus a darker area in a resulting image.

In some embodiments, the drilling bit 150 is a tool used to crush or cut rock. The drilling bit 150 may be on the bottom of the BHA disposed on a drillstring. The drilling bit 150 may be changed when it becomes excessively dull or stops making progress. The drilling bit 150 may work by scraping or crushing the rock, or both, as part of a rotational motion. The drilling bit 150 may be a hammer bit that pounds the rock vertically in a fashion similar to an air hammer.

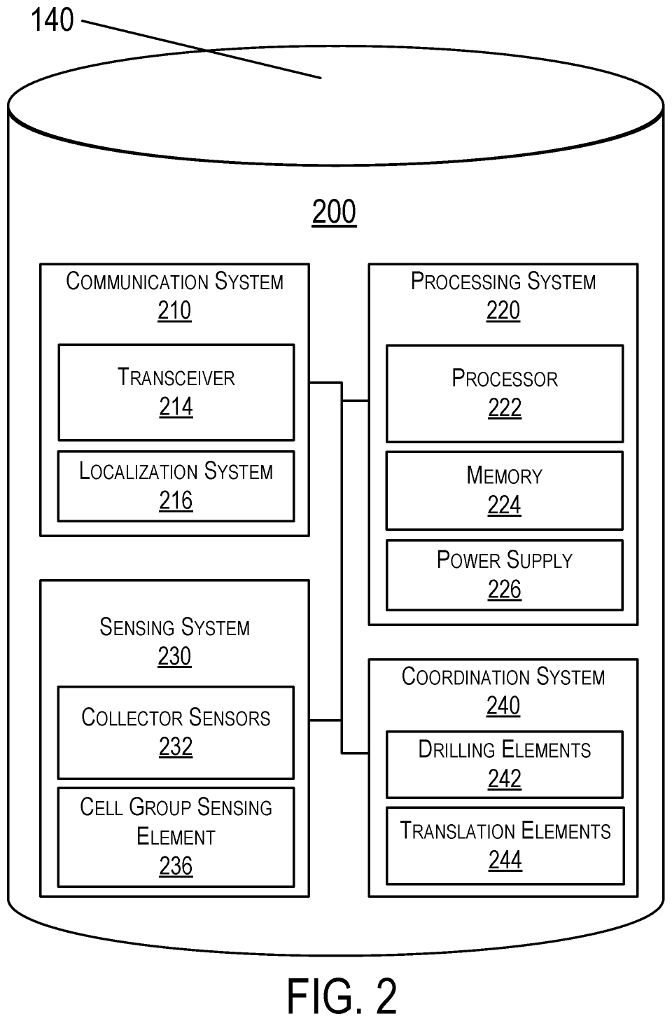

FIG. 2 shows a schematic diagram showing various systems disposed in the imaging device 140. In some embodiments, the imaging device 140 is mounted in a sub-assembly of the assembly 100 just above the drilling bit 150. This sub-assembly may be defined by a cylindrical housing 200 that extends along the central axis 120 thereof. During drilling operations, the imaging device 140 may start autonomously upon detecting a triggering condition. The triggering condition may a result from comparing predetermined rock formation characteristics with a specific set of data collected by one or more systems of the imaging device 140. In this regard, scanning performed by the imaging device 140 may be automatically activated upon identifying that the predetermined rock formation characteristics have been met. These rock formation characteristics may include information relating to a depth and a thickness of the rock formation.

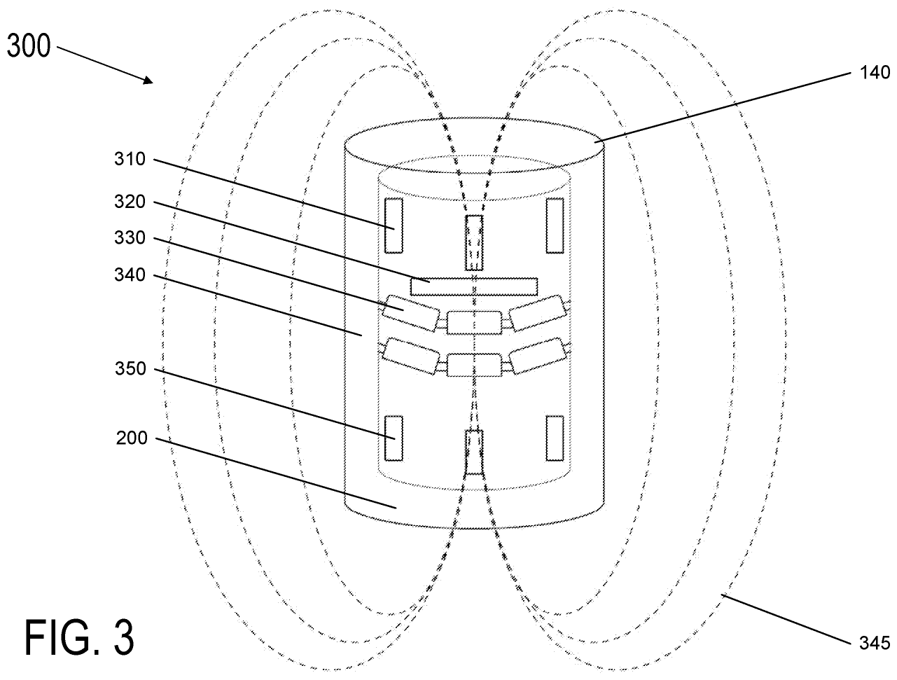

Upon activation, the imaging device 140 may generate composite images representative of three-dimensional (3D) renderings of an area surrounding the imaging device. The composite images may be generated using information collected using one or more systems. The information may be transmitted in real-time to a control system located on a surface. As described in more detail in reference to FIG. 3, the imaging device 140 includes hardware and/or software configured to use magnetic fields and radio frequency waves that generate composite images in the form of slices of the rock formation. These slices make it possible to perform virtual coring operations as the assembly 100 moves along the wellbore.

During drilling operations, the imaging device 140 may move along the wellbore 180 with the assembly 100. The imaging device 140 may remain at a predetermined distance from the drilling bit 150 such that the position of the imaging device 140 may be monitored with respect to the location of the drilling bit 150. In some embodiments, the imaging device 140 is completely enclosed in the cylindrical housing 200 containing a communication system 210, a processing system 220, a sensing system 230, and a coordination system 240. The communication system 210 may include communication devices such as a transceiver 214, and a localization system 216. The transceiver 214 may transmit and receive communication signals. Specifically, the transceiver 214 may communicate with one or more control systems located at a remote location. The transceiver 214 may communicate wirelessly using a wide range of frequencies and by establishing a communication link. In some embodiments, high or ultrahigh frequencies (i.e., between 10 KHz to 10 GHz) may be implemented. The localization system 216 may include one or more geospatial location identification components that collect information associated with a geospatial location of the imaging device 140 with respect to the rock formation or with respect to the drilling bit 150.

The processing system 220 may include a processor 222, a memory 224, and a power supply 226. The power supply 226 may be a battery or wired connection for providing electrical energy to the imaging device 140. In some embodiments, the battery is charged using electrical connectors (not shown). The processor 222 may perform computational processes simultaneously and/or sequentially. The processor 222 may determine information to be transmitted and processes to be performed using information received or collected. Similarly, the processor 222 may control collection and exchange of geospatial information through the localization system 216.

As noted above, the processor 222 may perform real-time coring during the drilling operations with the real-time coring including identifying one or more downhole characteristics in real-time. The processor 222 may generate at least one composite image representative of a 3D rendering. The at least one composite image may be processed in association with a timestamp and location information. The processor 222 may compare a status of the rock formation with predetermined rock formation characteristics. The predetermined rock formation characteristics may include information relating to a depth and a thickness of the rock formation. The processor 222 may trigger the triggering condition when the status of the rock formation equals the predetermined rock formation characteristics. Further, the memory 224 may store stores the at least one composite image by indexing the at least one composite image based on the timestamp and by sorting the at least one composite image based on the location information.

The sensing system 230 may include collector sensors 232 and a cell group sensing element 236. The collector sensors 232 may be sensors that collect physical data from the environment surrounding the imaging device 140 (i.e., the rock formation and/or the surface). The collector sensors 232 may be sensors that collect physical data from the imaging device 140 itself (i.e., internal temperature, internal pressure, or internal humidity). The collector sensors 232 may be lightweight sensors requiring a small footprint. These sensors may monitor a status of the rock formation during the drilling operations. These sensors may exchange information with each other and supply it to the processor 222 for analysis. The cell group sensing element 236 may be a logging tool of an electrical type that establishes communication links with one or more additional devices disposed on the surface or at a remote location. The cell group sensing element 236 may identify trends, characteristics or properties (i.e., such as pressure or temperature changes) relating to the movement of the imaging device 140 in relation to the rock formation. The cell group sensing element 236 may stabilize communications associated with the transceiver 214 by preventing magnetic interference between the transceiver 214 and the rest of the imaging device 140. The power supply 226 may be operationally connected to the cell group sensing system 236 and including connections (not shown) for collecting energy and producing electrical energy as a result.

The coordination system 240 may include drilling elements 242 and translation elements 244. The drilling elements 242 may include nozzles and bit cutters disposed in the drilling bit 150. The translation elements 244 may be mechanisms that identify and track the positioning of the imaging device 140 with respect to one or more instructions indicated for the movement of the assembly 100 and the rock formation.

FIG. 3 is a perspective view 300 showing various components disposed in the imaging device 140. In some embodiments, the imaging device 140 is mounted as discussed with respect to FIGS. 1 and 2. The imaging device 140 may include one or more radio frequency receivers 310, at least one radio frequency coil 320, one or more gradient coils 330, a main magnet 340, and one or more frequency transmitters 350. The radio frequency coils 320, the gradient coils 330, and the main magnet 340 may be disposed on an internal surface of the cylindrical housing 200 and around the central axis 120. The radio frequency receivers 310 and the frequency transmitters 350 may be disposed at opposite ends of the cylindrical housing 200 and around the central axis 200. An area of interest (AOI) 360 for scanning the rock formation may be a volume defines by a wellbore radius of investigation that extends from the cylindrical housing 200 and towards the rock formation forming a wheel shape.

The main magnet 340 may be a large magnet that produces a main magnetic field. The main magnet 340 may be located around the entirety of the cylindrical housing 200. The main magnetic field 345 may produce two distinct effects that work together to create an image. The main magnetic field 345 causes water molecules in the rock formation to resonate in a specific radio-frequency (RF) range. This resonance causes the water molecules to function as a tuned radio receiver and transmitter during any imaging processes. In this case, MRI scanning may involve a two-way radio communication between the water molecules and the cylindrical housing 200.

The main magnet 340 may be a superconducting magnet type, a resistive magnet type, or a permanent magnet type.

A superconducting magnet type is capable of producing a strong and stable magnetic field. The superconducting magnet type is an electromagnet that operates in a superconducting state. This means that, in the superconducting magnet type, very small superconducting wires can carry very large currents without overheating, which is typical of more conventional conductors like copper. There are two requirements for superconductivity. During normal operation, the superconducting magnet type allows for electrical current to flow through a superconductor without dissipating any energy or producing heat. If the temperature of the conductor rises above the critical superconducting temperature, the current may begin to produce heat and the current is rapidly reduced. The superconducting magnet type may be in the form of cylindrical coils or solenoid coils with the main magnetic field 345 in an internal bore. The resistive magnet type is made from an electrical conductor such as copper. The name “resistive” refers to the inherent electrical resistance that is present in all materials except for superconductors. Heat may be produced when a current is passed through a resistive conductor to produce a magnetic field. The permanent magnet type does not require either electrical power or coolants for operation.

The gradient coils 330 (i.e., gradient magnets) may be three separate sets of gradient coils. These gradient coils 330 are oriented so that gradients can be produced in the three orthogonal directions (i.e., the x, y, and z directions). A gradient is a change in field strength from one point to another in the AOI in the rock formation. The gradients are produced by the gradient coils 330, which are contained within the cylindrical housing 200 of the imaging device 130. During an imaging procedure the gradients are turned on and off many times. This action produces the sound or noise that comes from the magnet. Two or more of the gradient coils 330 may be used together to produce a gradient in any desired direction. These gradients are used to perform many different functions during the image acquisition process, such as identifying spatial characteristics by producing slices and voxels of the rock formation.

The radio frequency coils 320, the radio frequency receivers 310, and the radio frequency transmitters 350 may form a RF system that provides the communications link with the AOI in the rock formation for the purpose of producing an image. The imaging device 130 uses RF signals to transmit the scanned image from the rock formation. The RF energy used is a form of non-ionizing radiation. The RF pulses that are applied to the AOI are absorbed by the rock formation and converted to heat. A small amount of the energy is emitted by the radio formation as signals used to produce an image. The radio frequency coils 320 may be located within the magnet assembly and relatively close to the patient's body. In the imaging device 130, these coils function as the antennae for both transmitting signals to and receiving signals from the AOI.

The radio frequency receivers 310 and the radio frequency transmitters 350 are used to generate RF energy, which is applied to the coils and then transmitted to the rock formation. The energy is generated as a series of discrete RF pulses. The characteristics of a composite image are determined by the specific sequence of RF pulses.

The radio frequency transmitters 350 may include RF modulators and/or power amplifiers to produce pulses of RF energy. The radio frequency transmitters 350 are capable of producing high power outputs on the order of several thousand watts. The actual RF power required is determined by the strength of the main magnetic field 345.

A short time after a sequence of RF pulses is transmitted to the rock formation, the resonating AOI will respond by returning an RF signal. These signals are picked up by the radio frequency coils 320 and processed by the radio frequency receivers 310. The signals are converted into a digital form and transferred to the processor 222 and the memory 224, where they are temporarily stored.

In some embodiments, the cell group sensing element 236 is configured to shield portions of the imaging device 130 against external RF signals. In some embodiments, shielding may be performed by surrounding it with an electrically conducted enclosure that follows the cylindrical housing 200. These enclosures may be made out of sheet metal and copper screen wire. The cell group sensing element 236.

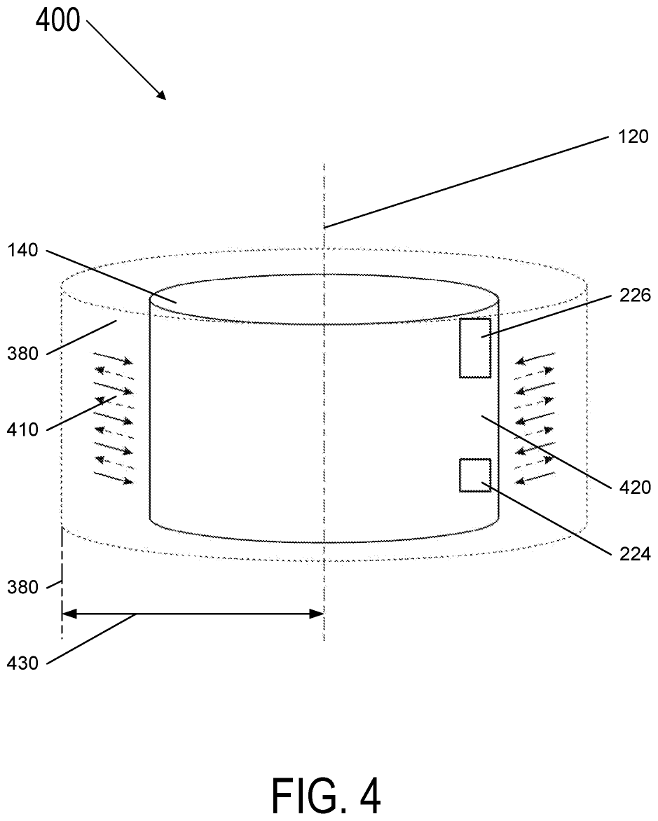

FIG. 4 shows a perspective view 400 of the imaging device 130 during an imaging operation. The imaging device 130 may operate upon receiving an instruction for operation, a triggering condition, or automatically upon detecting a predetermined parameter or calculation. In the perspective view 400, the imaging device 130 performs a scanning operation from the central axis 120 in the direction of the rock formation over a radius of investigation 430. The actual area scanned is an AOI covered from an outer surface 420 of the cylindrical housing 200 to an end of the radius of investigation 430 in which multiple RF signals 410 slice the entirety of the volume surrounding the imaging device 130.

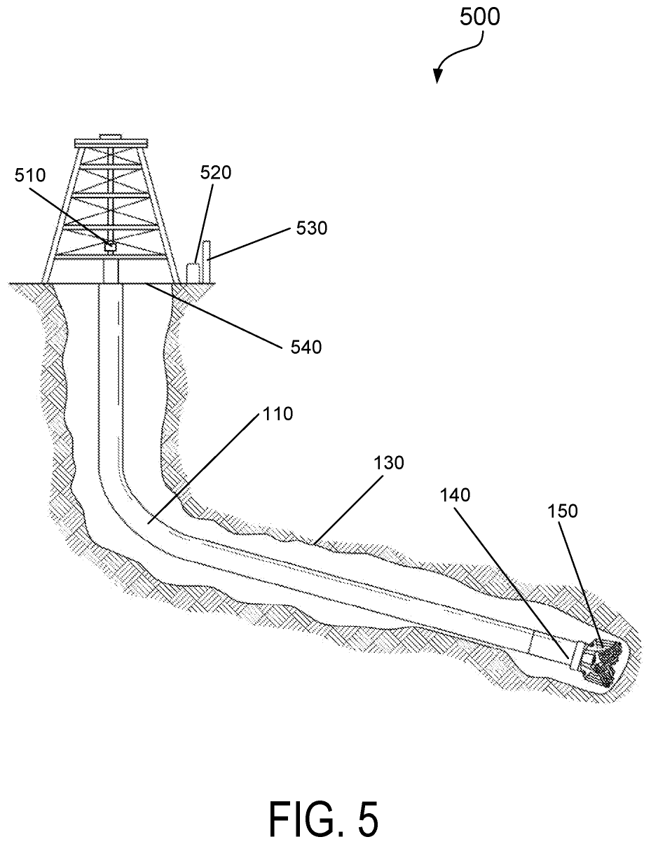

FIG. 5 shows an example of the imaging device 130 being used during drilling operations for a well in a well system 500 in accordance to one or more embodiments. The well system 500 may include surface equipment including actuating devices 510, sensors 520, and a control system 530 connected to one another using hardware and/or software to create various interfaces. Further, the well system 500 may be propped by structures from a surface 540. The well system 500 includes the wellbore 130 extending from the surface 540 to an underground formation. The underground formation may have porous areas including hydrocarbon pools that may be accessed through the wellbore 130. In some embodiments, the imaging device 140 is translated in a vertical direction along the wellbore 130 using the surface equipment.

In some embodiments, during drilling operations, the control system 530 may collect and record wellhead data for the well system 500. The control system 530 may include flow regulating devices that are operable to control the flow of substances into and out of the wellbore 130. For example, the control system 530 may include one or more production valves (not shown separately) that are operable to control the flow of fluids in the well system 500 during drilling operations. In some embodiments, the control system 530 may regulate the movement of the assembly 100 through the conveyance mechanism by modifying power supplied to the actuating devices 510.

The control system 530 may include a reservoir simulator (not shown). The reservoir simulator may include hardware and/or software with functionality for performing one or more coring operations regarding the formation and/or performing one or more slicing analysis. The reservoir simulator may perform production analysis and estimation based on one or more characteristics associated to the formation. These characteristics may include information associated to reservoir behavior to optimize production based on the analysis of core porosity, permeability, fluid saturation, grain density, lithology, and/or texture of the rock formation. Further, the reservoir simulator may include a memory for storing well logs and data regarding core samples for performing simulations. While the reservoir simulator may be included in the control system 530 at a well site, the reservoir simulator may be located away from the well site. In some embodiments, the reservoir simulator may include a computer system disposed to estimate a depth of the imaging device 140 at any given time. The reservoir simulator may use the memory for compiling and storing historical data about the drilling operation.

In some embodiments, the actuating devices 510 may be motors or pumps connected to the assembly 100 and the control system 530. The control system 530 may be coupled to the sensors 520 to sense characteristics of substances and conditions in the wellbore 130, passing through or otherwise located in the well system 500. The sensors 520 may include a surface temperature sensor.

In some embodiments, the measurements are recorded in real-time, and are available for review or use within seconds, minutes or hours of the condition being sensed (e.g., the measurements are available within 1 hour of the condition being sensed). In such an embodiment, the coring operations may be referred to as being performed “real-time.” Real-time data may enable an operator of the well system 500 to assess a relatively current state of the well system 500, and make real-time decisions regarding drilling operations.

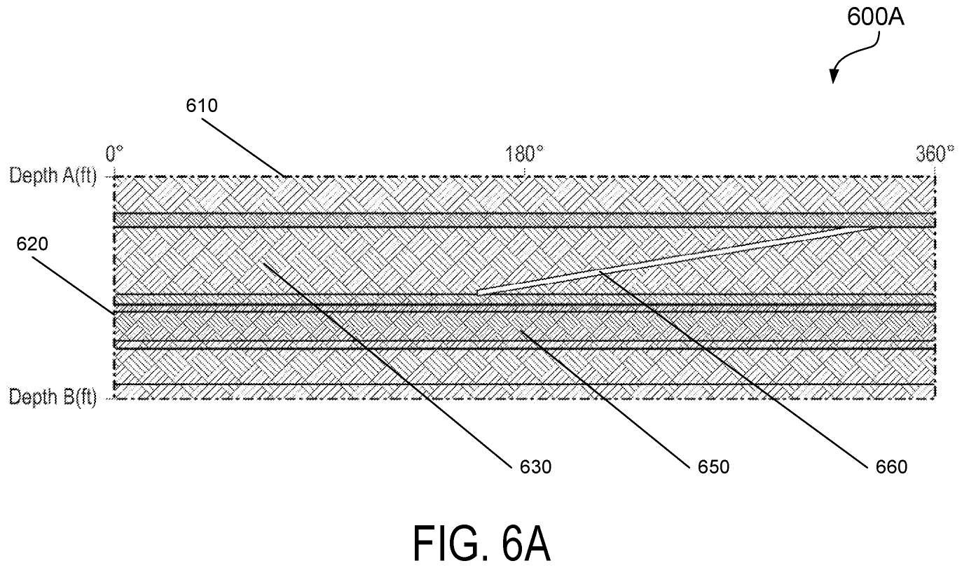

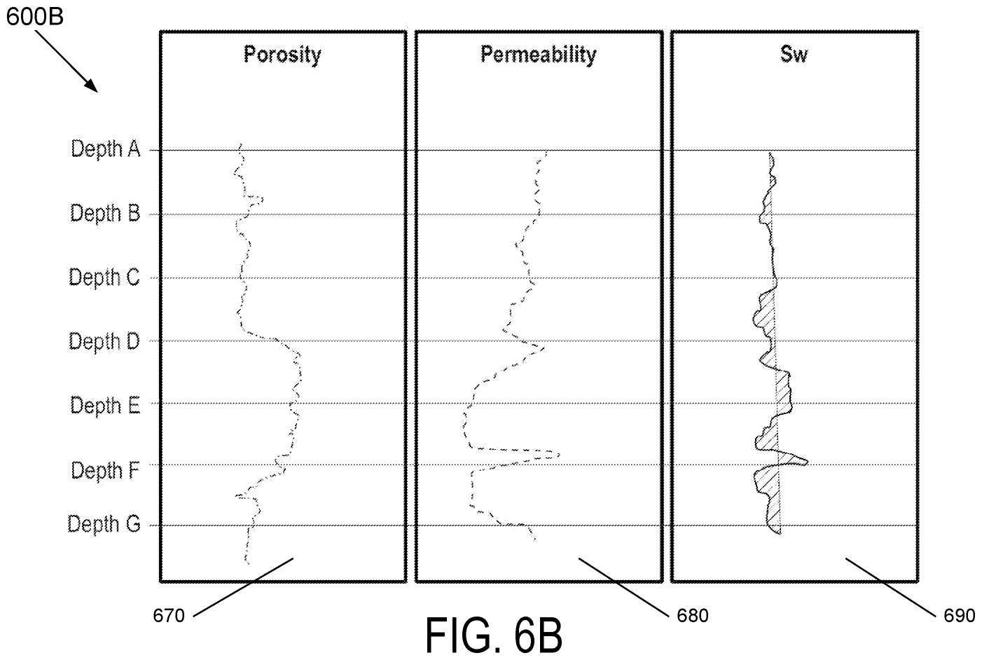

FIGS. 6A and 6B are directed towards examples of imaging outputs. FIG. 6A shows an image 600A covering a 360 degrees view of a section 610 of the formation. The image 600A shows changes of a lithology 630 of the formation and at least one fracture 660. In FIG. 6A, multiple layers 650 are shown along a predefined depth range 620. The depth range expanding between a depth value A to a depth value B. In FIG. 6A, the image 600A is in two-dimensions to allow identification of the fracture 660. In some embodiments, this image may be a disk shape representative of a cross-section of the formation. These two types of images may be compiled to generate a three-dimensional representation of the formation. FIG. 6B shows an image 600B with three different levels of information associated to individual depth values between a depth value A to a depth value G. This information includes multiple parameters and these parameters may be a porosity tracking parameter 670, a permeability tracking parameter 680, and a water saturation (Sw) tracking parameter 690.

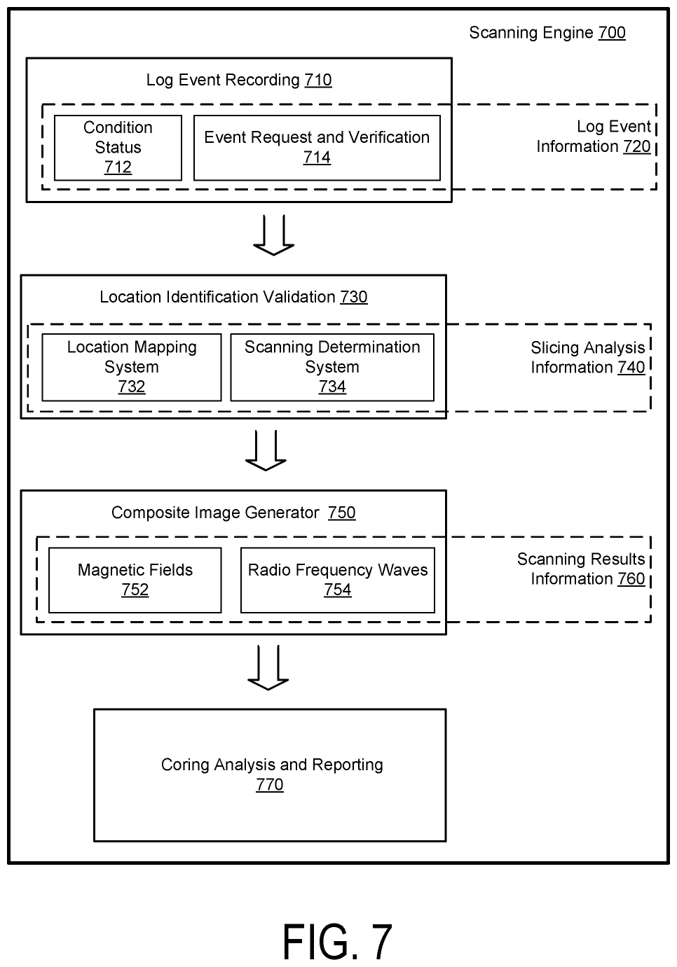

FIG. 7 shows a process for generating a coring analysis and report 770 as part of performing advanced scanning operations using a scanning engine 700. In one or more embodiments, the coring analysis and report 770 is based on various different levels of information and processing. The coring analysis and report 770 may include log event information 720, slicing analysis information 740, and scanning results information 760. The scanning engine 700 may use any of the information included at any given time during operation in order to obtain the coring analysis and report 770. The various information may be processed and controlled by one or more of the components described in reference to FIGS. 1-5.

In some embodiments, the scanning engine 700 may perform coring operations by measuring rock formation characteristics at downhole conditions from virtual cores obtained through scanning. As noted above, the rock formation characteristics may be petrophysical properties of the rock at downhole conditions, which may include fluid saturation, permeability, or porosity indicators without the need to of retrieving and cutting physical cores.

The log event information 720 may be used after a log event recording 710 is triggered. The scanning engine 700 may create, or obtain, an instruction indicating an area of interest anywhere on the rock formation based on a point of interest selected by a user or a decision-making server. In this context, a user is any person responsible for directly, or indirectly, triggering the log event recording 710. Further, a decision-making server is any entity that triggers the log event recording 710 directly by sending instructions that may be configured by a person or machine learning algorithm. In log event recording 710, the area of interest may be assessed through a condition status 712 and an event request and verification 714, which may provide raw information relating to the condition of the imaging device 140 and its location in the wellbore 130 with respect to the area of interest.

The slicing analysis information 740 may be used after a location identification validation 730 is triggered. The scanning engine 100 may obtain slicing analysis information 740 including one or more rock formation characteristics for any area of interest. Specifically, the scanning engine 100 may access slicing analysis information 740 based on a specific combination of the condition status 712 and the event request and verification 714. The scanning engine 700 may determine the location of the assembly 100 and the imaging device 140 via an location mapping system 732 and a scanning determination system 734. The scanning engine 700 may use the location mapping system 732 to analyze drilling operation information of the selected area of interest to determine the relations and interconnections between historical data of the rock formation and data collected during the drilling operations. Further, the scanning engine 700 may use the scanning determination system 734 to identify and categorize types of assets in the area of interest. Assets may be any change in the structure of the rock formation along the area of interest.

The scanning results information 760 may be used after a composite image generator 750 is triggered. The scanning engine 100 may analyze the results of the location identification validation 730 and test the slicing analysis information 740 in accordance with coring practices. The scanning engine 700 may use magnetic fields 752 and radio frequency waves 754 to determine an exact location of assets in the area of interest. In this regard, the composite image generator 750 may create 3D images by combining scanning results information 760 with multiple images including the slices used for the slicing analysis information.

In some embodiments, the scanning engine 100 outputs the coring analysis and report 770 based on the various information processed without affecting the characteristics of the rock formation through surface conditions because the scanning engine 700 allows for rock formation characteristics to be evaluated at downhole conditions. As noted above, in reference to FIGS. 1-6, virtual cores obtained using the imaging device 140 and the scanning engine 700 provide coring at downhole condition, and reduce the time required to analyze core data for better understanding of the reservoir and filed development processes. By eliminating downtime associated to retrieving physical core samples, the imaging device 140 and the scanning engine 700 optimize drilling times while accurately determining rock formation characteristics such as fluid saturation, permeability, and porosity of an AOI in a given rock formation.

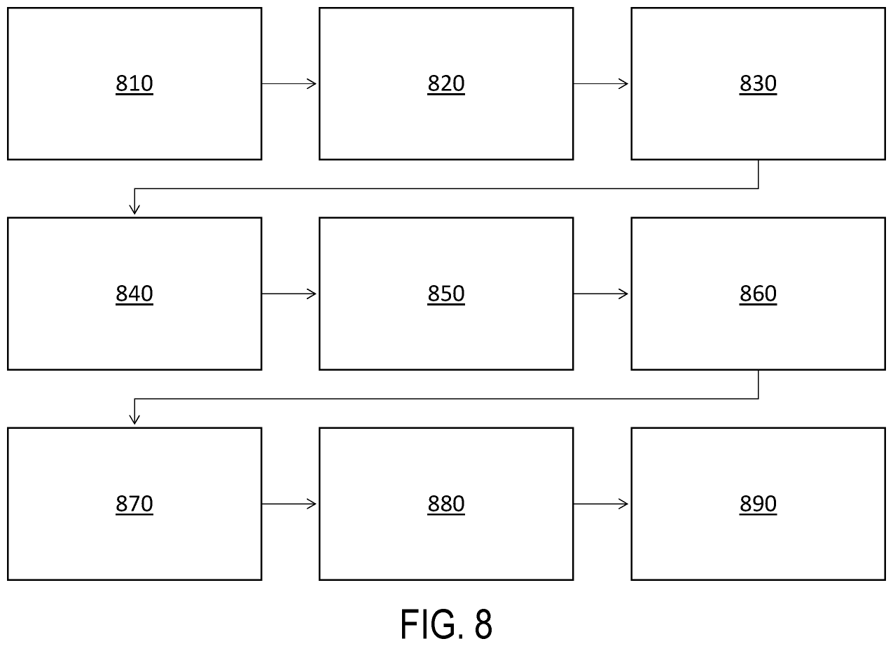

FIG. 8 shows a process including scanning the rock formation, generating a composite image based on the scans, and performing coring operations to identify one or more rock formation characteristics. The composite image may be the image shown and described in reference to FIGS. 6A and 6B. In Block 810, the process sets or checks the entirety of the tools that will be used for communication and data collection. These tools may include tools associated to the imaging device 140 and an overall drilling assembly. In Block 820, the imaging device 140 is lowered at a shallow depth from the surface and a test coring is performed. The imaging device 140 performs the coring of the shallow depth and a predefined number of slices or images are generated. In Block 830, the imaging device 140 is lowered further down as drilling progresses and after the test coring is scored and approved to proceed. In Block 840, virtual coring may be started. The virtual coring starts by collecting of slices as the imaging device 140 is lowered towards and throughout the formation. The virtual coring may be performed at equally spaced intervals, through uneven intervals, or throughout the entirety of the drilling operation. In Block 850, it is determined whether the imaging device 140 has performed virtual coring through the selected intervals. If the imaging device 140 has not performed the virtual coring an a given time interval is incomplete, the entire assembly may be raised to re-log any necessary intervals. As described in reference to FIGS. 1-7, the virtual cores may be transmitted directly to a remote location or saved in an internal memory of the imaging device 140. In Block 860, the process includes pulling the imaging device 140 out of the hole formed during the drilling process through disassembling and disconnection of the imaging device 140 from the assembly 100. In Block 870, the internal memory of the imaging device 140 is backed up and restored for a new virtual coring sequence. In Block 880, data collected by the imaging device 140 is processed in the manner discussed in reference to FIGS. 1-5 and images representatives of the properties sampled during the virtual coring are generated. In Block 890, the images generated and any metadata is compiled to form composite images in the manner described in reference to FIGS. 6A-7. Once the composite image is generated, an operator may navigate through the different slices of the image and evaluate each section individually along corresponding information relating to properties of the formation.

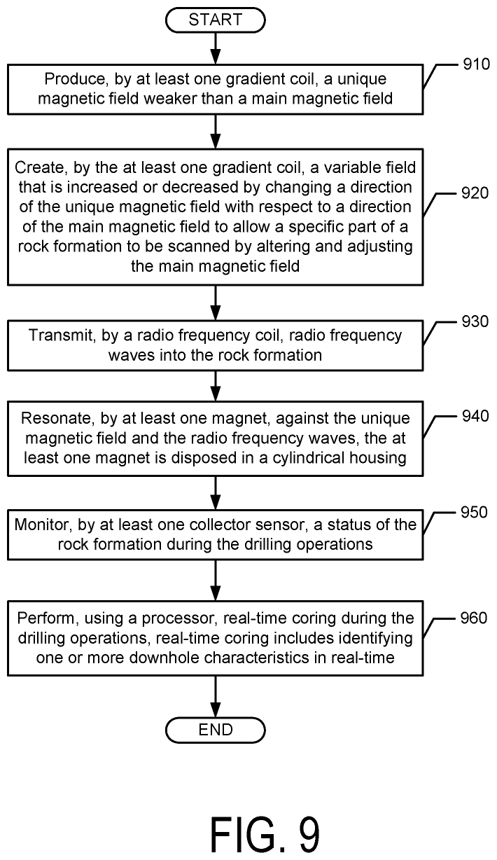

FIG. 9 shows a flowchart in accordance with one or more embodiments. Specifically, FIG. 9 describes a method for performing real-time coring using an imaging device included in an assembly located in a wellbore during drilling operations. In some embodiments, the method may be implemented using the devices described in reference to FIGS. 1-5. While the various blocks in FIG. 9 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The method allows the imaging device 140 to scan the rock formation at the downhole by acquiring 3D images in real-time. The real-time collection of images may be used as virtual cores for coring during drilling operations.

In Block 910, a unique magnetic field is produced to be weaker than a main magnetic field using at least one gradient coil.

In Block 920, a variable field is created using the at least one gradient coil. The variable field is increased or decreased by changing a direction of the unique magnetic field with respect to a direction of the main magnetic field to allow a specific part of a rock formation to be scanned by altering and adjusting the main magnetic field.

In Block 930, radio frequency waves are transmitted into the rock formation using a radio frequency coil.

In Block 940, at least one magnet resonates against the unique magnetic field and the radio frequency waves. The at least one magnet is disposed in a cylindrical housing.

In Block 950, the a status of the rock formation is monitored using at least one collector sensor during drilling operations.

In Block 960, real-time coring is performed using a processor during the drilling operations. The real-time coring includes identifying one or more downhole characteristics of the rock formation in real-time.

While FIGS. 1-9 show various configurations of components, other configurations may be used without departing from the scope of the disclosure. For example, various components in FIG. 1-5 may be combined to create a single component. As another example, the functionality performed by a single component may be performed by two or more components.

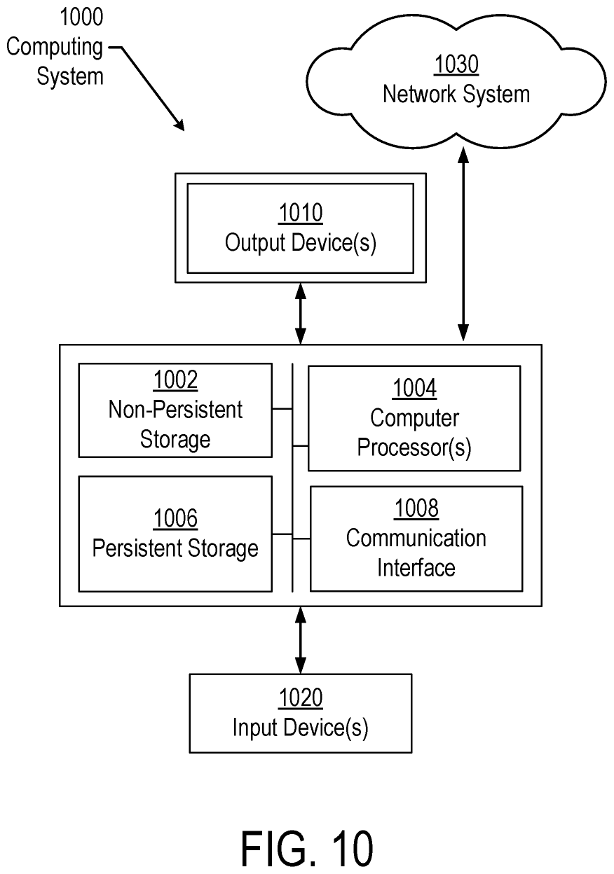

As shown in FIG. 10, the computing system 1000 may include one or more computer processor(s) 1004, non-persistent storage 1002 (e.g., random access memory (RAM), cache memory, or flash memory), one or more persistent storage 1006 (e.g., a hard disk), a communication interface 1008 (transmitters and/or receivers) and numerous other elements and functionalities. The computer processor(s) 1004 may be an integrated circuit for processing instructions. The computing system 1000 may also include one or more input device(s) 1020, such as a touchscreen, keyboard, mouse, microphone, touchpad, electronic pen, or any other type of input device. In some embodiments, the one or more input device(s) 1020 may be the sensors 520 described in reference to FIG. 5 connected to the imaging device 140 described in reference to FIG. 1. Further, the computing system 1000 may include one or more output device(s) 1010, such as a screen (e.g., a liquid crystal display (LCD), a plasma display, or touchscreen), a printer, external storage, or any other output device. One or more of the output device(s) may be the same or different from the input device(s). The computing system 1000 may be connected to a network system 1030 (e.g., a local area network (LAN), a wide area network (WAN) such as the Internet, mobile network, or any other type of network) via a network interface connection (not shown).

In one or more embodiments, for example, the input device 1020 may be coupled to a receiver and a transmitter used for exchanging communication with one or more peripherals connected to the network system 1030. The receiver may receive information relating to one or more reflected signals as described in reference to FIGS. 2-4. The transmitter may relay information received by the receiver to other elements in the computing system 1000. Further, the computer processor(s) 1004 may be configured for performing or aiding in implementing the processes described in reference to FIGS. 7, 8, and/or 9.

Further, one or more elements of the computing system 1000 may be located at a remote location and be connected to the other elements over the network system 1030. The network system 1030 may be a cloud-based interface performing processing at a remote location from the well site and connected to the other elements over a network. In this case, the computing system 1000 may be connected through a remote connection established using a 5G connection, such as protocols established in Release 15 and subsequent releases of the 3GPP/New Radio (NR) standards.

The computing system in FIG. 10 may implement and/or be connected to a data repository. For example, one type of data repository is a database (i.e., like databases). A database is a collection of information configured for ease of data retrieval, modification, re-organization, and deletion. In some embodiments, the databases include published/measured data relating to the method, the assemblies, and the devices as described in reference to FIGS. 1-4, 7, and 8.

While FIGS. 1-10 show various configurations of components, other configurations may be used without departing from the scope of the disclosure. For example, various components in FIGS. 1-4, 7, 8, and 10 may be combined to create a single component. As another example, the functionality performed by a single component may be performed by two or more components.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. An imaging device included in an assembly located in a wellbore during drilling operations, the imaging device comprising:
a cylindrical housing that extends along a central axis thereof;
at least one gradient coil configured to produce a unique magnetic field weaker than a main magnetic field, the at least one gradient coil creating a variable field that is increased or decreased by changing a direction of the unique magnetic field with respect to a direction of the main magnetic field to allow a specific part of a rock formation to be scanned by altering and adjusting the main magnetic field;
at least one radio frequency coil configured to transmit radio frequency waves into the rock formation;
at least one magnet disposed in the cylindrical housing that resonates against the unique magnetic field and the radio frequency waves;
at least one collector sensor that monitors a status of the rock formation during the drilling operations;
a power source dedicated to powering the imaging device; and
a processor that performs real-time coring during the drilling operations, the real-time coring comprising identifying one or more downhole characteristics in real-time.

2. The imaging device of claim 1, wherein the assembly comprises a piping element, the imaging device, and a drilling bit, the imaging device being located directly above the drilling bit.

3. The imaging device of claim 1, wherein the processor further:
generates, based on a condition, at least one composite image representative of a three-dimensional (3D) rendering based on the direction of the unique magnetic field, the direction of the main magnetic field, the radio frequency waves, and the status of the rock formation during the drilling operation, the at least one composite image being associated to a timestamp and location information in which the at least one composite image is generated, and
identifies the one or more downhole characteristics in the at least one composite image, the one or more downhole characteristics comprising permeability, porosity, and saturation.

4. The imaging device of claim 3, wherein the imaging device further comprises:
a memory that stores the at least one composite image, indexes the at least one composite image based on the timestamp, and sorts the at least one composite image based on the location information.

5. The imaging device of claim 4, the imaging device further comprising:
a transceiver that:
establishes a communication link with a control system that is not located in the wellbore,
transmits a backup copy of the at least one composite image to the control system, and
receives one or more instruction signals from the control system; and
a cell group sensing element that stabilizes communications associated with the transceiver by preventing magnetic interference between the transceiver and the rest of the imaging device.

6. The imaging device of claim 4, wherein the processor further:
compares the status of the rock formation with predetermined rock formation characteristics, the predetermined rock formation characteristics including information relating to a depth and a thickness of the rock formation, and
triggers the condition when the status of the rock formation equals the predetermined rock formation characteristics.

7. The imaging device of claim 5, wherein the at least one composite image comprises a plurality of composite images, each composite image comprising a unique timestamp.

8. The imaging device of claim 1, wherein the imaging device comprises three gradient coils, the three gradient coils oriented to scan in a first direction that is parallel to the central axis, a second direction that is perpendicular to the second direction, and a third direction that is perpendicular to both the first direction and the second direction.

9. The imaging device of claim 8, wherein the imaging device comprises a plurality of radio frequency coils, the plurality of radio frequency coils acting as antennae that transmit pulses and receive signals from the rock formation.

10. The imaging device of claim 9 wherein the imaging device comprises a single magnet, the single magnet being of a resistive type or a permanent type.

11. The imaging device of claim 10, wherein the imaging device comprises a plurality of collector sensors, the plurality of collector sensors monitoring a performance status and a durability status for each of the three gradient coils, the plurality of radio frequency coils, and the single magnet.

12. An assembly located in a wellbore during drilling operations, the assembly comprising:
a piping element comprising an aperture that extends along a central axis thereof;
an imaging device comprising:
a cylindrical housing that extends along the central axis,
at least one gradient coil configured to produce a unique magnetic field weaker than a main magnetic field, the at least one gradient coil creating a variable field that is increased or decreased by changing a direction of the unique magnetic field with respect to a direction of the main magnetic field to allow a specific part of a rock formation to be scanned by altering and adjusting the main magnetic field,
a radio frequency coil configured to transmit radio frequency waves into the rock formation,
at least one magnet disposed in the cylindrical housing that resonates against the unique magnetic field and the radio frequency waves,
at least one collector sensor that monitors a status of the rock formation during the drilling operations, and
a power source dedicated to powering the imaging device, and
a processor that performs real-time coring during the drilling operations, the real-time coring comprises identifying one or more downhole characteristics in real-time; and
a drilling bit comprising a plurality of drilling elements that assist in crushing or cutting the rock formation.

13. The assembly of claim 12, wherein the processor further:
generates, based on a condition, at least one composite image representative of a three-dimensional (3D) rendering based on the direction of the unique magnetic field, the direction of the main magnetic field, the radio frequency waves, and the status of the rock formation during the drilling operation, the at least one composite image being associated to a timestamp and location information in which the at least one composite image is generated,
identifies the one or more downhole characteristics in the at least one composite image, the one or more downhole characteristics comprising permeability, porosity, and saturation.

14. The assembly of claim 13, wherein the imaging device further comprises:
a memory that stores the at least one composite image, indexes the at least one composite image based on the timestamp, and sorts the at least one composite image based on the location information.

15. The assembly of claim 14, wherein the imaging device further comprises:
a transceiver that:
establishes a communication link with a control system that is not located in the wellbore,
transmits a backup copy of the at least one composite image to the control system, and
receives one or more instruction signals from the control system; and
a cell group sensing element that stabilizes communications associated with the transceiver by preventing magnetic interference between the transceiver and the rest of the assembly.

16. The assembly of claim 14, wherein the processor further:
compares the status of the rock formation with predetermined rock formation characteristics, the predetermined rock formation characteristics including information relating to a depth and a thickness of the rock formation, and
triggers the condition when the status of the rock formation equals the predetermined rock formation characteristics.

17. The assembly of claim 14, wherein the at least one composite image comprises a plurality of composite images, each composite image comprising a unique timestamp.

18. The assembly of claim 12, wherein the imaging device comprises:
three gradient coils, the three gradient coils oriented to scan in a first direction that is parallel to the central axis, a second direction that is perpendicular to the second direction, and a third direction that is perpendicular to both the first direction and the second direction, and
a plurality of radio frequency coils, the plurality of radio frequency coils acting as antennae that transmit pulses and receive signals from the rock formation.

19. The assembly of claim 18, wherein the imaging device comprises:
a single magnet, the single magnet being of a resistive type or a permanent type, and
a plurality of collector sensors, the plurality of collector sensors monitoring a performance status and a durability status for each of the three gradient coils, the plurality of radio frequency coils, and the single magnet.

20. A method for performing real-time coring using an imaging device included in an assembly located in a wellbore during drilling operations, the method comprising:
producing, by at least one gradient coil, a unique magnetic field weaker than a main magnetic field;
creating, by the at least one gradient coil, a variable field that is increased or decreased by changing a direction of the unique magnetic field with respect to a direction of the main magnetic field to allow a specific part of a rock formation to be scanned by altering and adjusting the main magnetic field;
transmitting, by a radio frequency coil, radio frequency waves into the rock formation;
resonating, by at least one magnet, against the unique magnetic field and the radio frequency waves, the at least one magnet being disposed in a cylindrical housing;
monitoring, by at least one collector sensor, a status of the rock formation during the drilling operations; and
performing, using a processor, real-time coring during the drilling operations, the real-time coring comprising identifying one or more downhole characteristics in real-time;
wherein the imaging device comprises a power source dedicated to powering the imaging device.
